(19) United States
(12) Patent Application Publication
(10) Pub. No.: US 2012/0074326 A1
(43) Pub. Date: Mar. 29, 2012

(54) APPARATUS AND METHOD FOR NEUTRON DETECTION WITH NEUTRON-ABSORBING CALORIMETRIC GAMMA DETECTORS

(76) Inventors: Guntram Pausch, Dresden (DE); Claus Michael Herbach, Haan (DE); Jürgen Stein, Wuppertal (DE)

(21) Appl. No.: 13/376,609

(22) PCT Filed: Jul. 27, 2009
(86) PCT No.: PCT/EP2009/059692

§ 371 Date: Dec. 7, 2011

(51) Int. Cl. G01T 1/20

(52) U.S. Cl. 250/362; 250/367

(57) ABSTRACT

An apparatus for detecting neutron radiation includes a gamma ray scintillator having an inorganic material with an attenuation length L_{g} of less than 10 cm for gamma rays of 5 MeV energy to provide for high gamma ray stopping power for energetic gamma rays within the -gamma ray scintillator. The gamma ray scintillator includes components with a product of neutron capture cross section and concentration leading to an absorption length Lₙ for thermal neutrons which is larger than 0.5 cm but smaller than five times the attenuation length L_{g} for 5 MeV gammas, the gamma ray scintillator having a diameter or edge length of at least 50% of L_{g}. The apparatus includes an evaluation device to determine the amount of light, detected by a light detector for one scintillation event The evaluation device classifies detected radiation as neutrons when the measured total gamma energy Eₛᵤₘ is above 2,614 MeV.

### CROSS-REFERENCE TO RELATED APPLICATION

This application is a National Stage of PCT International Patent Application No. PCT/EP2009/059692, filed Jul. 27, 2009, the disclosure of which is incorporated herein by reference.

### BACKGROUND OF THE INVENTION

1. Field of the Invention

Aspects of the present invention relates to an apparatus for detecting neutron radiation, preferably thermal (slow) neutrons, utilizing a gamma ray scintillator for indirect detection.

2. Description of the Related Art

In spite of a broad variety of methods and devices which are available for neutron detection, the common ³He tube is still dominating in most applications which require neutron counting with highest efficiency at lowest expense. However, a shortage of ³He is expected, so that there is a need for alternatives.

Such alternative detectors are known in the prior art. Knoll, Radiation Detection and Measurement, 3rd edition 2000, page 506, states that all common reactions used to detect neutrons are reactions with charged particle emission. More specifically, the possible reaction products used for detection are the recoil nuclei (mostly protons), tritons, alpha-particles and fission fragments. Nevertheless, gamma rays following a neutron capture reaction are used in some specialized detectors but these applications are relatively rare.

A detector using a gamma ray scintillator has been disclosed in U.S. Pat. No. 7,525,101 B2 of Grodzins. Grodzins discloses a detector, comprising a neutron scintillator, being opaque for incoming optical photons, sandwiched between two light guides, one of the light guides serving as a gamma ray scintillator also. This detector also generally utilizes heavy charged particle emission following a neutron capture. Grodzins does mention ⁶Li, ¹⁰B, ¹¹³Cd, or ¹⁵⁷Gd as neutron capture materials. Those are used in combination with a ZnS scintillation component, wherein the charged particles loose energy, causing the ZnS material to scintillate with the emission of about 50 optical photons for every kV of energy loss, thus resulting in hundreds of thousands of optical light quanta after each neutron capture.

As a consequence, the detector disclosed by Grodzins is emitting light quanta to both sides of the neutron scintillator sheet. The detector itself then measures the coincidence of the light detection on both sides of the neutron scintillator sheet. Such a coincident measurement is seen as a signature for a neutron-capture in neutron scintillation sheet. This detector is discriminating against gamma radiation, as a gamma quant would be stopped in the gamma scintillator only, which is optically separated from the other light guide.

Apart from the complicated setup, the Grodzins disclosure has the disadvantage that it cannot discriminate neutron events against cosmic background radiation and other energetic charged particle radiation, which may cause scintillation within the neutron absorber material or Cerenkov light in the light guides, followed by a light emission into both light guides also.

Another disadvantage of the Grodzins disclosure is an unsatisfactory neutron-gamma discrimination in case of using ¹¹³Cd or ¹⁵⁷Gd as neutron capture materials. In this case, the detector is sensitive to external gammas as well. Pulses generated by detecting external gamma radiation in the neutron scintillator cannot be distinguished from pulses due to gammas produced by neutron capture reactions.

Reeder, Nuclear Instruments and Methods in Physics Research A 340 (1994) 371, proposes a neutron detector made of Gadolinium Oxyorthosilicate (GSO) surrounded by plastic scintillators operated as total gamma absorption spectrometer in coincidence with the GSO. As plastic scintillators are distinguished by a large attenuation length for energetic gamma rays, the proposed total absorption spectrometer would either be quite inefficient or would require large volumes of plastic scintillator. A further disadvantage is that there are difficulties when collecting the light from the plastic material with a reasonable number of photodetectors. In addition, large plastic layers not only moderate but also absorb a part of the neutron flux, thus reducing the neutron detector efficiency. A further disadvantage is that background, due to Compton scattering of gamma rays from an external source in the neutron detector, followed by an interaction of the scattered gamma with the gamma detector, cannot be eliminated.

Another neutron detector utilizing a gamma ray scintillator is disclosed by Bell in U.S. Pat. No. 6,011,266. Bell is using a gamma ray scintillator, surrounded by a neutron sensitive material, preferably comprising boron. The neutron capture reaction results in fission of the neutron sensitive material into an alpha-particle and a ⁷Li ion, whereby the first excited state of the lithium ion decays via emission of a single gamma ray at 478 keV which is then detected by the scintillation detector. At the same time, the detector disclosed in Bell is sensible to gamma rays, resulting from an incident radiation field, as the neutron sensitive material is not acting as a shield against gamma rays.

One of the disadvantages of such a detector is that the single gamma ray following the decay of the first excited state of ⁷Li lies within an energy region, where a lot of other gamma rays are present. It is, therefore, necessary to measure this single decay very accurately in order to achieve at least reasonable results, thus increasing the technical complexity and the related costs substantially. Furthermore, a discrimination against charged particle radiation, for example such of cosmic origin, is difficult if not impossible with a detector as disclosed by Bell.

### SUMMARY OF THE INVENTION

In summary, none of the known neutron detector concepts is competitive with a ³He tube if decisive parameters like neutron detection efficiency per volume, neutron detection efficiency per, cost, gamma suppression factor, simplicity and ruggedness and availability of detector materials are considered simultaneously.

Therefore, one of the purposes of the invention is to overcome the disadvantages of the prior art and to provide an efficient neutron detector with a simple setup and a high confidentiality of neutron detection.

According to an embodiment of the invention, an apparatus for detecting neutron radiation, preferably thermal neutrons, includes at least a gamma ray scintillator, said scintillator comprising an inorganic material with an attenuation length L_{g} of less than 10 cm, preferably less than 5 cm for gamma rays of 5 MeV energy in order to provide for high gamma ray stopping power for energetic gamma rays within the gamma ray scintillator, the gamma ray scintillator further comprising components with a product of neutron capture cross section and concentration leading to an absorption length Lₙ for thermal neutrons which is larger than 0.5 cm but smaller than five times the attenuation length L_{g}, preferably smaller than two times the attenuation length L_{g} for 5 MeV gammas in the said scintillator, the neutron absorbing components of the gamma ray scintillator releasing the energy deployed in the excited nuclei after neutron capture mainly via gamma radiation, the gamma ray scintillator having a diameter or edge length of at least 50% of L_{g}, preferably of at least L_{g}, in order to absorb an essential part of the gamma ray energy released after neutron capture in the scintillator. The apparatus is further comprising a light detector, optically coupled to the gamma ray scintillator in order to detect the amount of light in the gamma ray scintillator, and evaluation device coupled to the light detector, said device being able to determine the amount of light, detected by the light detector for one scintillation event, that amount being in a known relation to the energy deployed by gamma radiation in the gamma ray scintillator. The evaluation device is configured to classify detected radiation as neutrons when the measured total gamma energy Eₛᵤₘ is above 2,614 MeV.

According to an embodiment of the invention, terms diameter and edge length mentioned above refer to the size of the gamma ray scintillator.

According to an embodiment of the invention, in case it is a cylindrical scintillator, the term diameter or edge length refers to either the diameter or the height—edge length—of the cylinder, whichever is smaller.

According to an embodiment of the invention, the evaluation device is configured to classify detected radiation as neutrons when the measured total gamma energy is below a predetermined threshold, preferably below 10 MeV, in addition.

According to an embodiment of the invention, the gamma ray scintillator is comprising at least one of the elements Chlorine (Cl), Manganese (Mn), Cobalt (Co), Selenium (Se), Bromine (Br), Iodine (I), Caesium (Cs), Praseodymium (Pr), Lanthanum (La), Holmium (Ho), Ytterbium (Y), Lutetium (Lu), Hafnium (Hf), Tantalum (Ta), Tungsten (W), or Mercury (Hg) as a constituent. Most preferably, the gamma ray scintillator is selected from a group of Lead Tungstate (PWO), Sodium Iodide (NaI), Caesium Iodide (CsI), or Lanthanum Bromide (LaBr₃).

According to embodiment, the gamma ray scintillator includes at least one of the elements Cadmium (Cd), Samarium (Sm), Dysprosium (Dy), Europium (Eu), Gadolinium (Gd), Iridium (Ir), Indium (In), or Mercury (Hg) as an activator or dopant. For example, the gamma ray scintillator may be selected from a group of Europium doped Strontium Iodide (SI₂) or Calcium Flouride (CaF₂).

According to another embodiment of the invention, the gamma ray scintillator is split in at least three separate parts, each of these parts being coupled to a light detector so that the signals from the different parts can be distinguished, where the evaluation device is configured to classify detected radiation as neutrons when at least two different parts have detected a signal being due to gamma interaction, following a neutron capture in the neutron absorbing components of the gamma ray scintillator. The light detector used to distinguish signals from the different parts of the gamma ray scintillator may be a multi-anode photomultiplier tube.

According to an embodiment of the invention, the parts of the gamma ray scintillator as described in the previous paragraph may form several more or less integral parts of a single detector or, as an alternative, may comprise at least three individual gamma ray scintillators, the signals of which being commonly evaluated as described above.

In yet another embodiment of the invention, the gamma ray scintillator is at least in part surrounded by a shield section, said shield section comprising a scintillator, the emission light of said scintillator being measured by a light detector, where the output signals of the light detector are evaluated by the common evaluation device of the apparatus. The evaluation device is preferably configured to classify detected radiation as neutrons when no signal with an energy of above a certain shield threshold has been detected from the shield section scintillator in the same time frame (anti-coincidence), said shield threshold being determined according to the steps of measuring the thickness t (in cm) of the scintillator in the third section, then determining the energy Eₘᵢₙ (in MeV) corresponding to the energy deposition of minimum ionizing particles covering a distance t in said scintillator, by multiplying said thickness with the density of the scintillator material, given in g/cm³, and with the energy loss of minimum ionizing particles in said scintillator, given in MeV/(g/cm²), and by finally setting the shield threshold below said energy. The shield section is preferably optically coupled to the light detector of the gamma ray scintillator and the evaluation device is preferably configured to distinguish the signals from the gamma ray scintillator and shield section by their signal properties. It is of advantage also when a wavelength shifter is mounted in between the scintillator of the shield section and the photo detector.

According to an embodiment of the invention, the scintillator of the shield section may be selected from a group of materials comprising constituents with low atomic number Z, serving as a neutron moderator for fast neutrons.

According to an embodiment of the invention, a method for detecting neutrons, preferably thermal neutrons, using an apparatus as described above, comprising the following steps of capturing a neutron in the gamma ray scintillator, then measuring the light emitted from the gamma ray scintillator as a consequence of the gamma radiation energy loss, and determining the total energy loss of the gamma radiation, following a neutron capture, from the light emitted from the gamma ray scintillator of the apparatus and finally classifying an event as neutron capture when the total energy loss measured is above 2,614 MeV. Preferably, an event is classified as neutron capture only when the total energy loss measured is below a predetermined threshold, preferably below 10 MeV.

According to another method for detecting neutrons, preferably thermal neutrons, an apparatus with a gamma ray scintillator, being split in at least three parts as described above is used to utilize the following method: capturing a neutron in the gamma ray scintillator, then measuring the light emitted from the gamma ray scintillator as a consequence of the gamma radiation energy loss, then determining the total energy loss of the gamma radiation, following a neutron capture, from the light emitted from the gamma ray scintillator and finally classifying an event as neutron capture when the total energy loss measured is above 2,614 MeV and when an energy loss is measured in at least two parts of the gamma scintillator.

According to an embodiment of the invention, a method for detecting neutrons, preferably thermal neutrons, using an apparatus with a shield detector as described above is disclosed also, said method comprising the following steps of capturing a neutron in the gamma ray scintillator, then measuring the light emitted from the gamma ray scintillator as a consequence of the gamma radiation energy loss before determining the total energy loss of the gamma radiation, following a neutron capture, from the light emitted from the gamma ray scintillator, and classifying an event as neutron capture when the total energy loss measured is above 2,614 MeV. According to this method, it is required in addition that no signal with an energy of above a certain shield threshold has been detected from the shield scintillator in the same time frame (anti-coincidence) in order to qualify an event as being due to neutron capture, said shield threshold being determined according to the following steps of measuring the thickness t (in cm) of the shield scintillator, determining the energy Eₘᵢₙ (in MeV) corresponding to the energy deposition of minimum ionizing particles covering a distance t in said shield scintillator, by multiplying said thickness with the density of the scintillator material, given in g/cm³, and with the energy loss of minimum ionizing particles in said scintillator, given in MeV/(g/cm²), and then setting the shield threshold below said energy. Preferably the total energy loss of the gamma radiation, following a neutron capture is determined from the light emitted from both the gamma ray scintillator and the shield scintillator.

According to another method, using the inventive apparatus with shield, an event is classified as neutron capture only when the total energy loss of the gamma radiation, following a neutron capture, is below a predetermined threshold, preferably below 10 MeV.

Further disclosed is method, using the inventive apparatus with shield, according to which an event is classified as external gamma radiation if an energy loss below the shield threshold is observed in the shield scintillator but no energy loss is observed in the gamma ray scintillator.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an embodiment of the invention with the cylindrical scintillator and a light detector,

FIG. 2 shows the an embodiment of the detector with a surrounding shield detector,

FIG. 3 shows an embodiment of the detector, using just one single light detector, and

FIG. 4 shows the various decay times of signals, emitted from different scintillator materials according to aspects of the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

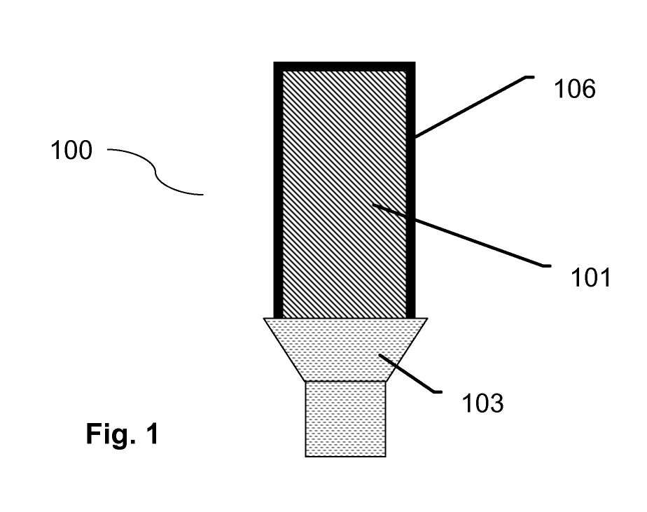

FIG. 1 shows a longitudinal cut through an embodiment. The detector 100 and two of its main sections are shown here. A gamma scintillator material 101 can be seen, which is mounted on a light detector 103. An example of the light detector 103 is a photo multiplier tube or an array of Geiger-mode avalanche photodiodes (G-APD), although the invention is not limited thereto. The gamma scintillator material may be encapsulated with a material 106. In a preferred embodiment, that material 106 may be of sufficient thickness and, at the same time, comprise sufficient material with low atomic number Z no as to serve as a moderator for fast neutrons.

The gamma scintillator material is selected in a way that it contains constituents or dopants with a concentration and with a neutron capture cross section for thermal (slow) neutrons large enough to capture most of the thermal neutrons, hitting the detector.

The material within the gamma ray scintillator 101, being responsible for the neutron capture, is not a material, which substantially leads to fission or the emission of charged particles once the neutron has been captured, but is mainly releasing its excitation energy via gamma ray emission. Appropriate materials are, for instance, materials containing Chlorine (Cl), Manganese (Mg), Cobalt (Co), Selenium (Se), Bromine (Br), Iodine (I), Caesium (Cs), Praseodymium (Pr), Lanthanum (La), Holmium (Ho), Ytterbium (Y), Lutetium (Lu), Hafnium (Hf), Tantalum (Ta), Tungsten (W) or Mercury (Hg), especially when used as a constituent of the scintillator material. While not limited thereto, in an embodiment, the gamma ray scintillator 101 is made from either Lead Tungstate (PWO), Sodium Iodide (NaI), Cesium Iodide (CsI) or Lanthanum Bromide (LaBr₃).

Another way to increase the neutron capture rate in the gamma ray scintillator 101 is to dope the scintillator with feasible materials. Such materials may be Gadolinium (Gd), Cadmium (Cd), Europium (Eu), Samarium (Sm), Dysprosium (Dy), Iridium (Ir), Mercury (Hg), or Indium (In). This allows it to control the absorption rate for thermal neutrons by increasing or decreasing the concentration of the dopant within the gamma ray scintillator 101.

As every neutron capture deposits a considerable amount of excitation energy, mostly about 5 to 10 MeV, in the nucleus, depending on the capturing nuclide, this is roughly the energy which is released in form of multiple gamma quanta with energies ranging from a few keV up to some MeV. Contrary to that, the usual neutron capture reaction used in state of the art detectors lead to an energy release mostly by the emission of fission products and/or charged particles. Those processes are also often accompanied by gamma radiation, which, nevertheless, amounts only to a smaller part of the total energy release.

The apparatus utilizes a neutron capture, followed by the release of gamma quanta with a total energy somewhere in between 5 to 10 MeV. As a consequence, the detector concept with an efficient gamma scintillator allows to measure a substantial portion of those gamma quanta emitted and so to sufficiently discriminate events following neutron capture against radiation background, in particular against gamma radiation due to most radioactive decays.

It has to be noted that the gamma cascades following a neutron capture are emitted very fast so that the single gamma events can not be distinguished by the gamma scintillator 101. Therefore, the gamma scintillator 101 as such is summing up all gamma energies, producing an amount of light, which is mostly proportional to the total energy Eₛᵤₘ deposed in the scintillator material. The scintillator, therefore, cannot distinguish between a single high energy gamma and a multitude of lower energy gamma rays, absorbed in the same time window.

The gamma scintillator 101 is therefore designed to operate as a kind of calorimeter, thus summing up all energy deposited after a single neutron capture event. It is constructed and arranged in a way that maximizes the portion of the sum energy Eₛᵤₘ which is on average absorbed in the scintillation material, following a neutron capture in the neutron absorber, at minimum cost and minimum detector volume. Considering that, depending on the specific reaction used, only a part of the sum energy Eₛᵤₘ is in fact absorbed, it is advantageous to define an appropriate window, in other words a sum energy gate, in the detector. Only events with a sum energy Eₛᵤₘ within that window would then be identified as neutron captures with a sufficient certainty.

The evaluation device, not shown here, evaluating the signal output from the light detector 103, is set to define an event as neutron capture when the sum energy Eₛᵤₘ is larger than 2,614 MeV. With this condition for a lower threshold, the invention makes use of the fact that the highest single gamma energy resulting from one of the natural radioactive series has exactly 2,614 MeV, which is the gamma decay in ²⁰⁸TI, being part of the natural thorium radioactive series.

As it is highly unlikely to measure two independent gamma rays from two sources in coincidence, the threshold of 2,614 MeV is good enough to discriminate against natural or other background radiation.

It is worth noting that such a gamma calorimeter is an efficient detector for neutron capture gamma rays produced outside of the detector as well. This could improve the sensitivity of the inventive apparatus for detecting neutron sources. This is due to the fact that all materials surrounding a neutron source capture neutrons to more or less extent, finally capturing all the neutrons produced by the source. These processes are mostly followed by emission of energetic gammas, often with energies well above 3 MeV. Those gamma rays may contribute to the neutron signals in the inventive detector if they deposit a sufficient part of their energy in the gamma ray scintillator of the apparatus.

In order to operate the gamma scintillator in a calorimetric regime, it is advantageous to choose the size of the scintillator in dependence from the scintillator material in a way that a substantial portion of the gamma rays emitted after neutron capture can be stopped in the gamma scintillator. A very suitable material, for example, is Lead Tungstate (PWO or PbWO₄) as this material is distinguished by a striking stopping power for the gamma energies of interest, including the highest gamma energies, and a fairly high neutron capture capability due to Tungsten (W) which is one of the crystal constituents. The low light output (in photons per MeV) of PWO is acceptable with this application, because it does not require surpassing spectrometric performance. An also important aspect is that this material is easily available in large quantities for low cost.

It is advisable to use PWO scintillators with a diameter around 5 to 8 centimeters as the gamma ray scintillator of the apparatus. Such a detector is able to absorb (1) about 50% (or even more) of the thermal neutrons hitting the detector, and (2) more than 3 MeV of gamma energy in more than 50% of all cases when gamma rays with an energy above 4 MeV are produced in the volume of this detector.

Selecting the material for the gamma ray scintillator 101 appropriately, that is especially with an absorption length Lₙ for thermal neutrons larger than 0.5 cm but smaller than two times the attenuation length L_{g} for gamma radiation of 5 MeV, most of the neutrons will be captured far enough from the surface of the gamma ray scintillator 101 so that the following gamma emission will occur mostly within the gamma ray scintillator 101. In case the gamma ray scintillator is large enough, the absorption length may be larger than two times the attenuation length but should not exceed five times the attenuation length. As a consequence, the gamma source will be surrounded by the gamma ray scintillator more or less totally, thus increasing the gamma detection efficiency after neutron capture—and therefore the neutron detection efficiency—dramatically.

It may also be advisable to set a further, upper threshold for the sum energy Eₛᵤₘ at about 10 MeV. The total energy emitted after neutron capture usually does not exceed this value. Nevertheless, signals with energy signatures above that threshold may occur, following the passage of cosmic radiation, for example muons, through the gamma scintillator, especially when the detector is relatively large. Those events are discriminated and suppressed by the said threshold. Actually both, the lower and the upper, thresholds for the energy deposition in section two should be optimized in a way that the effect-to-background ratio is optimized for the scenario of interest.

The sum energy Eₛᵤₘ is usually measured in the gamma ray scintillator 101 by collecting and measuring the light produced in the gamma ray scintillator, using a light detector 103, and evaluating the measured signal from the light detector. One of the main neutron detection criteria is to generally require a sum energy Eₛᵤₘ higher than 2,614 MeV.

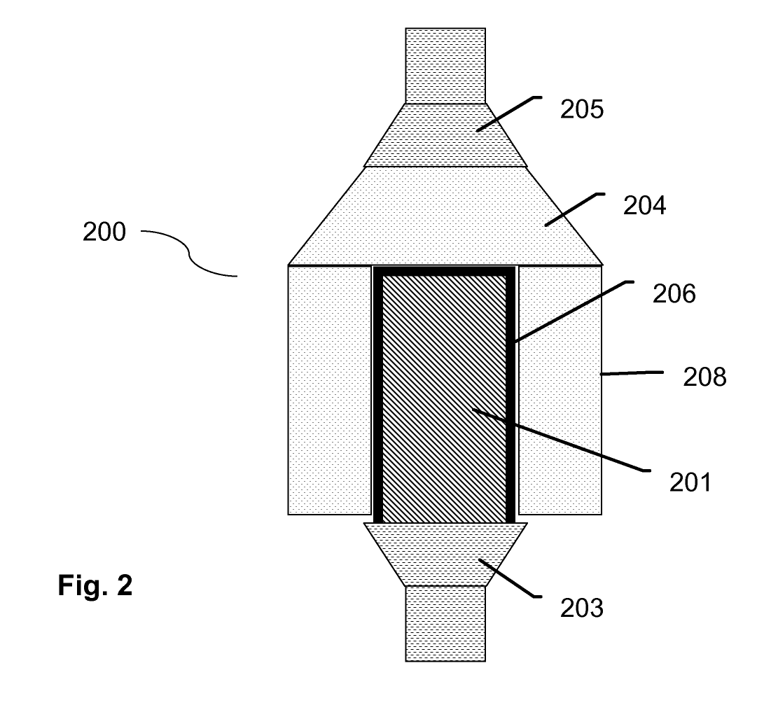

Another embodiment 200 of the invention is shown in FIG. 2. In the center, an apparatus as described in the first embodiment is to be seen, consisting of the gamma ray scintillator section 201 and the light detector 203. This detector may optionally be encapsulated with a material 206. The gamma scintillator portion of the detector is surrounded by a shield section 208, also comprising scintillator material 204. The light generated in this shield scintillator material is detected by an additional light detector 205.

While not limited thereto, the outer detector 208 serves as anti-coincidence shield against background radiation, for example cosmic radiation. When the shield section 208 is making use of a scintillator material with fairly low atomic numbers, it may also serve as a moderator for fast neutrons at the same time, thus allowing the apparatus to detect fast neutrons also. In this context it has to be mentioned that also the encapsulating material 206 of the detector may be selected in a way that this material serves as a neutron moderator, whereas such a selection of material is not limited to the embodiment with a surrounding shield section 208, but may also be used in combination with the other embodiments.

In an embodiment, the outer scintillator material 204 of the third section comprises plastic scintillator material. Such material is easily available and easy to handle.

The minimum energy deposition of penetrating charged particles in the scintillator of the shield section (in MeV) is given by the scintillator thickness (given in centimeters), multiplied with the density of the scintillator (given in grams per cubic centimeter) and with the energy loss of minimum ionizing particles (mips) in the corresponding scintillator material (given in MeV per gram per square centimeter). The latter is larger than 1 MeV/(g/cm²) for all common materials and larger than 1.5 MeV/(g/cm²) for all light materials, which allows an easy estimate of the said upper limit. For example, using a 2 cm Plastic (PVT) scintillator in the shield section, for instance, would result in an lower limit of about 2 1 1.5 MeV or about 3 MeV for a signal due to penetrating charged particles in the shield section. Those signals would have to be rejected as background. In this case, the anti-coincidence condition for the outer shield section could be that no energy has been detected in the shield section of more than 3 MeV.

As a consequence, an energy detected in the outer shield section of the apparatus of less than 3 MeV in the specific example, is likely not to origin from energetic cosmic radiation so that such a lower energy event, if detected in coincidence with gamma rays in the gamma ray scintillator 201, could be added to the sum energy Eₛᵤₘ as it may have its origin in the neutron capture within the gamma ray scintillator. If this signal is, however, actually due to external gamma radiation, the sum energy condition (Eₛᵤₘ>2614 keV) would reject the corresponding event.

It is worth mentioning that, when an energy deposition is observed in the shield section 208 which is smaller than the minimum energy deposition of penetrating charged particles, while no signal is observed in the gamma ray scintillator 201 at the same time, this could be taken as a signature for the detection of an external gamma ray in the shield section 208, thus using the shield scintillator as a detector (or spectrometer) for (external) gamma rays in parallel.

In a similar way, an energy deposition in the shield section 208 of less than the minimum energy deposition of penetrating charged particles, accompanied by a signal in the gamma ray scintillator 201 with a sum energy Eₛᵤₘ of less that 2,614 MeV could be taken as a signature for the detection of an external gamma which deposits energy in both sections due to Compton scattering followed by a second scattering act or photoadsorption. Therefore the combination of the shield section 208 and the gamma ray scintillator 201 could be operated as a detector (or spectrometer) for external gamma rays, while the sum energy criterion allows discriminating the neutron capture events.

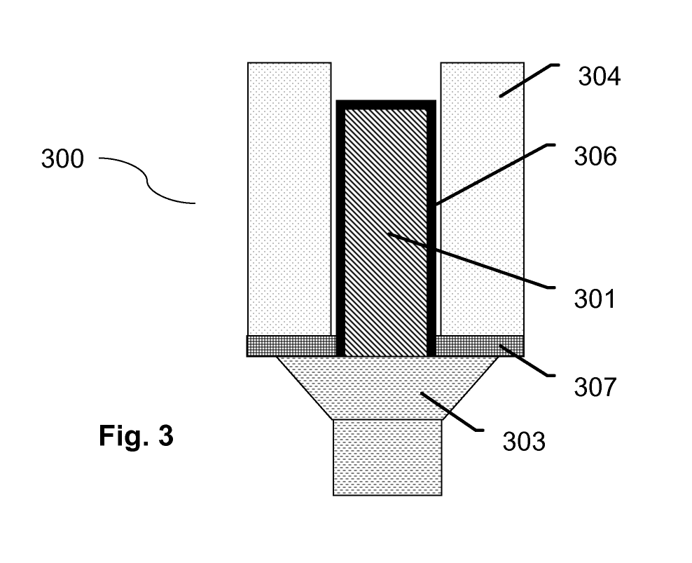

A further improvement of said shield detector variant is shown in FIG. 3. Again, a gamma ray scintillator 301 is mounted on a light detector 303. The gamma ray scintillator may again be surrounded by some kind of encapsulation 306.

Different from the other embodiments, the light sensitive surface of the light detector 303 is extending across the diameter, covered by the gamma ray detector 301. This outer range of the light detector 303 is optically coupled to a circular shield section, for example a plastic scintillator 304, surrounding the gamma ray scintillator 301 of the detector.

In order to properly distinguish the signal originating from the gamma ray scintillator 301 from the signals originating from the plastic scintillator 304, a wavelength shifter 307 may be added. Such a wavelength shifter should absorb the light from the plastic scintillator material 304, emitting light with a wave length similar to the wave length emitted from the gamma ray scintillator 301 so that it can be properly measured by the same light detector 303. In order to distinguish signals from the plastic scintillator 304 from those of the gamma ray scintillator 301, it is an advantage if the light, emitted from the wave length shifter 307 has a different decay time, thus allowing the evaluation device to clearly distinguish between the two signal sources as described above.

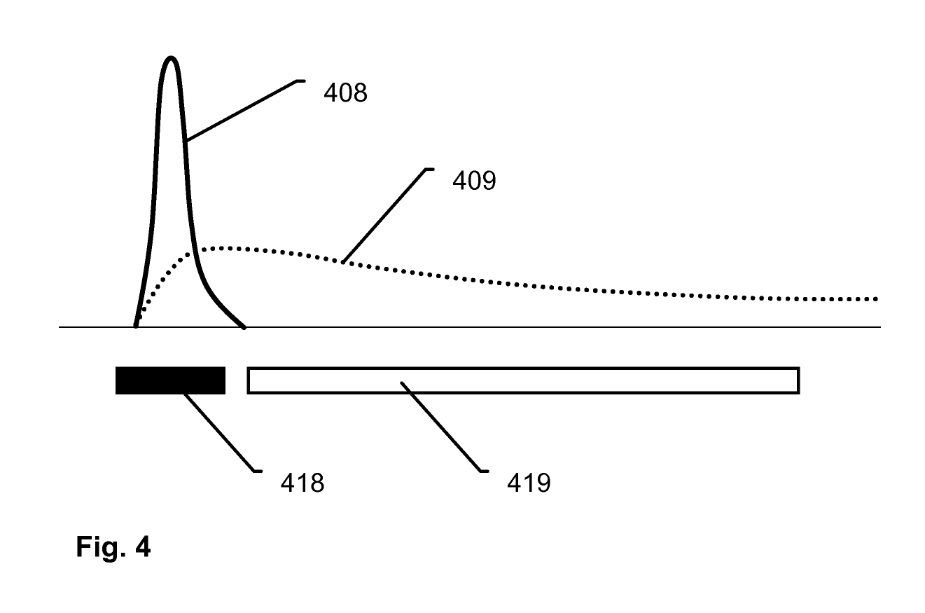

An example of the respective signals with different decay time is shown in FIG. 4. Pulse 408 is, for example, resulting from the gamma ray scintillator, consisting of a scintillation material with a short decay time. When the decay time of the light, emitted from the shield scintillator is much larger, as shown by the dashed line 409 in FIG. 4, those signals could easily be distinguished either by digital signal processing or by simply setting two timing windows 418 and 419 on the signal output of the light detector. In the same way signals from a gamma ray scintillator with a longer decay time could be easily distinguished from signals from a shield scintillator with a much shorter decay time.

It is not essential that the gamma ray scintillator comprises a single gamma scintillator material arranged in a single detector block read out with a common photodetector. In another embodiment, not shown here, the gamma ray scintillator, being used as a calorimeter, consists of multiple individual parts—detectors—, which could be based on different scintillator materials, and read out by individual photodetectors. In this case the sum energy Eₛᵤₘ is constructed by summing up all gamma energy contributions of the individual detectors, derived from the light signals of the individual detectors which occur within the same time frame (i.e., in coincidence). Such an embodiment is of advantage if detectors originally designed for another purpose, e.g. detection and spectroscopy of external gamma radiation can be involved in the inventive apparatus in order to reduce the total expense.

Yet another feature of the invention is the possibility to utilize the high multiplicity of the gamma rays emitted after a neutron capture. If the gamma ray scintillator is set up in a way that it comprises three or more detectors, the multiplicity may be evaluated also. If the light detector is split in a way that the light of for example four, gamma ray scintillators can be distinguished, for instance by using multi-anode photomultiplier tubes, it can also be evaluated separately. Therefore, in addition to measuring the sum energy Eₛᵤₘ, it is also possible to require a certain multiplicity of the measured gamma events.

Taking into account the limited efficiency of the detectors, it has proven to be an advantage to require at least two parts of such a gamma ray scintillator having detected gamma events. Especially in addition to the sum energy condition Eₛᵤₘ larger than 2,614 MeV this multiplicity condition further increases the accuracy of the inventive detector.

Summarizing the above, the invention claimed does provide a low cost, easy to set up detector, which is based on well known, inexpensive, of-the-shelf scintillator materials and well known, inexpensive, of-the-shelf photodetectors, and a method for evaluating the emitted signals with an efficiency and accuracy comparable to the state of the art ³He-counters.

Although a few embodiments of the present invention have been shown and described, it would be appreciated by those skilled in the art that changes may be made in this embodiment without departing from the principles and spirit of the invention, the scope of which is defined in the claims and their equivalents.

1. An apparatus for detecting neutron radiation comprising
a gamma ray scintillator comprising an inorganic material with an attenuation length L_{g} of less than 10 cm for gamma rays of 5 MeV energy in order to provide for high gamma ray stopping power for energetic gamma rays within the gamma ray scintillator;
a light detector, optically coupled to the gamma ray scintillator in order to detect an amount of light in the gamma ray scintillator; and
an evaluation device coupled to the light detector, the evaluation device being able to determine the amount of light, detected by the light detector for one scintillation event, that amount being in a known relation to the energy deployed by gamma radiation in the gamma ray scintillator,
wherein:
the gamma ray scintillator comprises components with a product of neutron capture cross section and concentration leading to an absorption length Lₙ for thermal neutrons which is larger than 0.5 cm but smaller than five times the attenuation length L_{g} for 5 MeV gammas in the said scintillator, the neutron absorbing components of the gamma ray scintillator releasing the energy deployed in the excited nuclei after neutron capture mainly via gamma radiation,
the gamma ray scintillator having a diameter or edge length of at least 50% of the attenuation length L_{g} in order to absorb an essential part of the gamma ray energy released after neutron capture in the scintillator, and
the evaluation device is configured to classify detected radiation as neutrons when the measured total gamma energy Eₛᵤₘ is above 2,614 MeV.

2. The apparatus of claim 1, wherein the evaluation device is configured to further classify detected radiation as neutrons when the measured total gamma energy is below a predetermined threshold.

3. The apparatus of claim 1, wherein the gamma ray scintillator comprises at least one of the elements Chlorine (Cl), Manganese (Mn), Cobalt (Co), Selenium (Se), Bromine (Br), Iodine (I), Caesium (Cs), Praseodymium (Pr), Lanthanum (La), Holmium (Ho), Ytterbium (Y), Lutetium (Lu), Hafnium (Hf), Tantalum (Ta), Tungsten (W), or Mercury (Hg) as a constituent.

4. The apparatus of claim 3, where the gamma ray scintillator is selected from a group of Lead Tungstate (PWO), Sodium Iodide (NaI), Caesium Iodide (CsI), or Lanthanum Bromide (LaBr₃).

5. The apparatus of the claim 1, wherein the gamma ray scintillator comprises at least one of the elements Cadmium (Cd), Samarium (Sm), Dysprosium (Dy), Europium (Eu), Gadolinium (Gd), Iridium (Ir), Indium (In), or Mercury (Hg) as an activator or dopant.

6. The apparatus of claim 5, wherein the gamma ray scintillator is selected from a group of Europium doped Strontium Iodide (SI₂) or Calcium Flouride (CaF₂).

7. The apparatus of claim 1, wherein:
the gamma ray scintillator is split in at least three separate parts, each of these parts being coupled to the light detector so that the signals from the different parts can be distinguished, and
the evaluation device is configured to classify detected radiation as neutrons when at least two different parts have detected a signal being due to gamma interaction, following a neutron capture in the neutron absorbing components of the gamma ray scintillator.

8. The apparatus of claim 7, wherein the light detector is able to distinguish signals from the different parts of the gamma ray scintillator comprises a multi-anode photomultiplier tube.

9. The apparatus of claim 1, where the gamma ray scintillator is at least in part surrounded by a shield section, said shield section comprising a scintillator, the emission light of said scintillator being measured by a light detector, where the output signals of the light detector are evaluated by the common evaluation device of the apparatus.

10. The apparatus of claim 9, wherein the evaluation device is configured to classify detected radiation as neutrons when no signal with an energy of above a certain shield threshold has been detected from the shield section scintillator in the same time frame, said shield threshold being determined according to the following steps:
measuring a thickness t (in cm) of the scintillator in the third section,
determining an energy Eₘᵢₙ (in MeV) corresponding to the energy deposition of minimum ionizing particles covering a distance t in said scintillator, by multiplying said thickness with the density of the scintillator material, given in g/cm³, and with the energy loss of minimum ionizing particles in said scintillator, given in MeV/(g/cm²), and
setting the shield threshold below said energy.

11. The apparatus of claim 10, wherein the shield section is optically coupled to the light detector of the gamma ray scintillator and the evaluation device is configured to distinguish the signals from the gamma ray scintillator and shield section by their signal properties.

12. The apparatus of claim 11, where further comprising a wavelength shifter mounted between the scintillator of the shield section and the light detector.

13. The apparatus of claim 9, where the scintillator is selected from a group of materials comprising constituents with low atomic number Z, serving as a neutron moderator for fast neutrons.

14. A method for detecting neutrons using the apparatus of claim 1, comprising:
capturing a neutron in the gamma ray scintillator;
measuring the light emitted from the gamma ray scintillator as a consequence of the gamma radiation energy loss;
determining the total energy loss of the gamma radiation, following a neutron capture, from the light emitted from the gamma ray scintillator of the apparatus; and
classifying an event as neutron capture when the total energy loss measured is above 2,614 MeV.

15. The method according to claim 14, wherein an event is classified as neutron capture only when the total energy loss measured is below a predetermined threshold.

16. A method for detecting neutrons using the apparatus of claim 7, comprising:
capturing a neutron in the gamma ray scintillator,
measuring the light emitted from the gamma ray scintillator as a consequence of the gamma radiation energy loss,
determining the total energy loss of the gamma radiation, following a neutron capture, from the light emitted from the gamma ray scintillator; and
classifying an event as neutron capture when the total energy loss measured is above 2,614 MeV and when an energy loss is measured in at least two parts of the gamma scintillator.

17. A method for detecting neutrons using the apparatus of claim 9, comprising:
capturing a neutron in the gamma ray scintillator,
measuring the light emitted from the gamma ray scintillator as a consequence of the gamma radiation energy loss,
determining the total energy loss of the gamma radiation, following a neutron capture, from the light emitted from the gamma ray scintillator,
classifying an event as neutron capture when the total energy loss measured is above 2,614 MeV; and
when no signal with an energy of above a certain shield threshold has been detected from the shield scintillator in the same time frame (anti-coincidence), determining the shield threshold by:
measuring a thickness t (in cm) of the shield scintillator,
determining an energy Eₘᵢₙ (in MeV) corresponding to the energy deposition of minimum ionizing particles covering a distance t in said shield scintillator, by multiplying said thickness with the density of the scintillator material, given in g/cm³, and with the energy loss of minimum ionizing particles in said scintillator, given in MeV/(g/cm²), and
setting the shield threshold below said energy.

18. The method according to claim 17, wherein a total energy loss of the gamma radiation, following a neutron capture is determined from the light emitted from both the gamma ray scintillator and the shield scintillator.

19. The method according to claim 17, wherein an event is classified as neutron capture only when the total energy loss of the gamma radiation, following a neutron capture, is below a predetermined threshold, preferably below 10 MeV.

20. The method according to claim 17, where an event is classified as external gamma radiation if an energy loss below the shield threshold is observed in the shield scintillator but no energy loss is observed in the gamma ray scintillator.

21. The apparatus of claim 1, wherein the attenuation length L_{g} is of less than than 5 cm for the gamma rays of 5 MeV energy.

22. The apparatus of claim 1, wherein the gamma ray scintillator comprises components with a product of neutron capture cross section and concentration leading to the absorption length Lₙ for thermal neutrons which is larger than 0.5 cm but smaller than two times the attenuation length L_{g} for 5 MeV gammas in the said scintillator.

23. The apparatus of claim 1, wherein the gamma ray scintillator has the diameter or edge length of at least the attenuation length L_{g}.

24. The apparatus of claim 1, wherein the evaluation device is configured to further classify detected radiation as neutrons when the measured total gamma energy is below 10 MeV.

25. The method according to claim 14, wherein an event is classified as neutron capture only when the total energy loss measured is below 10 MeV.

26. The method according to claim 18, wherein an event is classified as neutron capture only when the total energy loss of the gamma radiation, following a neutron capture, is below a predetermined threshold, preferably below 10 MeV.

27. The method according to claim 18, wherein an event is classified as external gamma radiation if an energy loss below the shield threshold is observed in the shield scintillator but no energy loss is observed in the gamma ray scintillator.
